(19) United States
(12) Patent Application Publication
(10) Pub. No.: US 2019/0220543 A1
(43) Pub. Date: Jul. 18, 2019

(54) SYSTEM AND METHOD FOR GLOBAL RESOLUTION OF A NETWORK PATH

(71) Applicant: CHRISTOPHER ANTHONY SILVA, FAIR HAVEN, NJ (US)

(72) Inventor: CHRISTOPHER ANTHONY SILVA, FAIR HAVEN, NJ (US)

(21) Appl. No.: 15/935,686

(22) Filed: Mar. 26, 2018

Related U.S. Application Data
(60) Provisional application No. 62/619,054, filed on Jan. 18, 2018.

(51) Int. Cl. G06F 17/30; G10L 15/26; G06F 9/54

(52) U.S. Cl. CPC G06F 17/30743; G10L 15/265; G06F 17/30076; G06F 9/547; G06F 17/30867

(57) ABSTRACT

A system and method for global resolution of a network path to one or more file types based on a specific sound or a specific combination of words, phrases and/or sounds. An application with a user interface at a networked device has access to a remote speech to text server via an advanced programmer interface (API) and to a globally accessible database. The globally accessible database can contain text translations of distinct words, phrases, and sounds that are associated with distinct network paths. Converted audio in a searchable format is queried at the global database for a match, if a match is found at the global database for the query, the network path associated with the match is returned from the global database to the networked device, and one or more files associated with the returned network path are opened at the networked device.

### BACKGROUND OF THE INVENTION

### Field of the Invention

The present invention relates to a system and method for global resolution of a network path to one or more file types based on a specific sound or a specific combination of words, phrases and/or sounds.

### Description of Related Art

Users of networks have several conventional ways to access a destination path via a plurality of devices such as personal computers, tablets, and mobile devices. Within those networked devices, there is a plurality of applications that are used to open various file types that can exist at these network paths such as, but not limited to, image viewers, document readers, spreadsheet applications, media players, development applications, presentation applications, etc. A user can either type in the network path of the location of the file or files, browse to the location through a network hierarchy of servers and nested folders within those servers, or via a shortcut that stores the path. When the file is accessed, the default application associated on that networked device for that file type opens the application. Current art limits the efficiencies of accessing these files to existing methodologies within specific applications.

U.S. Pat. No. 7,536,639 describes a numeric/voice name internet access architecture for accessing internet addresses based on a request from a wireless device. A WebNum system specifies a Private Numbering System that allows users to reach Internet Web sites by entering numbers instead of text Web URLs and host names on cellular telephones and other wireless Internet devices (WID). The Private Numbering System uses numerical digits, including specially-designated numeric combinations, standard telephone numbers, and international telephone numbers, that directs Web-enabled cell phones and WIDs to Internet Web sites and other Internet resources. A special WebNum database maps each WebNum back to an Internet URL, and interprets the WebNum as a pointer to an Internet resource.

U.S. Pat. No. 6,618,726 ('726 patent) describes a voice activated web browser to control a single application within a network connected device with a web browser and microphone. The '726 patent describes that speech is first categorized into “micro-domains” and then un-categorized words are further grouped into word groups. It is the intent to allow a user to speak into the microphone with natural language, i.e. complete sentences, and retrieve a result from a speech detention process. The '726 patent is directed to words and phrases comprising a plurality of templates associated with specific areas of interest. The match must be considered representing at least one of the specific areas of interest or it must generate a search string comprising: classifying parts of said identified words and phrases as at least one of names of people, locations, organizations, times, dates and amounts of money, marking all other words in said identified words and phrases as extraneous words.

Conventional Web browsers have provided access to World Wide Web pages on the internet by use of website bookmarks. Conventional Web browsers allow a user to save, or bookmark, a web page. The URL of the web page selected is saved locally to Web browser data, and the user can create a custom alphanumeric name for that bookmark if desired.

U.S. Pat. No. 6,965,864 ('864 patent) describes a voice activated hypermedia system using grammatical metadata. The '864 patent relates to a technique for embedding voice activated control information in HTML pages delivered on the World Wide Web. The '864 patent teaches controlling a Web browser via speech. The system uses, continuous, speaker independent speech recognition to allow anyone to walk up and use the system naturally without training.

Bookmarks within the Web browser can be customized by the user to have a corresponding speech identifier via a “Hot List”. The user can create these tags to have an association that is familiar to them, therefore they would be less likely to forget.

It is desirable to provide simplified global access by more than one user to one or more files associated with a respective network path that is agnostic to the application required to open the destination.

### SUMMARY OF THE INVENTION

The present invention simplifies global access to all file types through a single interface. Conventional networks, whether internet or intranet, are a series of interconnected endpoints which contain data, allow access to data, access data, or any combination thereof. It has been found that users are frequently presented the challenge of remembering and organizing the location of data. Data can be located in nested folders on other workstations, servers, storage arrays, cloud storage, websites, file transfer protocol servers, and any other networked device that has the capacity to store data. Specific applications are often needed to open various file types stored in these locations. As such, conventional “bookmarks” may exist in specialized applications such as web browsers, but that does not assist the users to access all file types through a single interface. Conventional “bookmarks” are also user driven and customized for that particular as to which bookmarks may be relevant to open in a particular application.

The present invention relates to a system and method for global resolution of a network path to one or more file types based on a specific sound or a specific combination of words, phrases and/or sounds. The present invention includes an application with a user interface, access to a remote speech to text server via an advanced programmer interface (API), and a globally accessible database. The globally accessible database can contain text translations of distinct words, phrases, and sounds that are associated with distinct network paths to an endpoint, or any item contained on an endpoint. Multiple words, phrases and sounds can be associated with a single network path. The application with a user interface can be an executable program running on a networked device containing components such as a processor, memory, storage, microphone, and operating system. The application with a user interface can be started by the user manually, or automatically on the networked device. The user can speak a word, phrase, or sound into the microphone of the networked device. The application with a user interface can connect to the remote speech to text server via the API and send the audio in digital or analog format to the remote speech to text server. The remote speech to text server can return the result to the networked device. Alternatively, the remote speech to text server can return the result directly to the globally accessible database for query against entries within the database. If a match is found, the network path associated with the phrase, word, or sound is transmitted to the application with user interface. At the application with user interface, the network path target is opened using a default application assigned to the file type within the operating system of the networked device running the application with user interface.

An example embodiment can be directed to multiple users working collaboratively on a single file, such as a presentation or document. The globally accessible database contains a word, phrase, or sound known to all users who need to access the file. The users can speak the word, phrase, or sound into the microphone of the networked device, such as a personal computer. The sound can be converted by a speech to text engine, and the result can be compared via a query in the commonly accessible database. In one embodiment, a server uses sound maps to transcribe one or more sounds into a searchable format. In another embodiment, the speech is analysed by a third party speech to text engine at the networked device. If a match is found, the network path of that file can be delivered to the networked device, and the default application for that file type, which is managed by the networked device operating system, is opened with the file. Alternatively, the networked device operating system can automatically open the file determined from the network path of the file. For example, the file can be a DOC file which is a document file format used by Microsoft Word, and also used with word processing software, including OpenOffice. A DOC file can contain formatted text, images, tables, graphs, charts, page formatting, and print settings. In this embodiment, the operating system can automatically open the document with Microsoft Word on the networked device and present the file to the user within the networked device user interface.

In an additional example embodiment, the network path delivered to the networked device can be a shared folder on the network, root access to a server or a workstation, or a telephone number. The present invention has the advantages of simplification and efficiency to access data through a user interface.

The invention will be more fully described by reference to the drawings.

### BRIEF DESCRIPTION OF THE DRAWINGS

FIG. 1 is a schematic diagram of a flow chart of a method for global resolution of a network path to one or more file types based on a specific sound or a specific combination of words, phrases and/or sounds resolution.

FIG. 2 is schematic diagram of a flow chart of a method for establishing a global accessible database of records based on a specific sound or a specific combination of words, phrases and/or sounds resolution.

FIG. 3 is a schematic diagram of a system for global resolution of a network path to one or more file types based on resolution of a specific sound or a specific combination of words, phrases and/or sounds.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

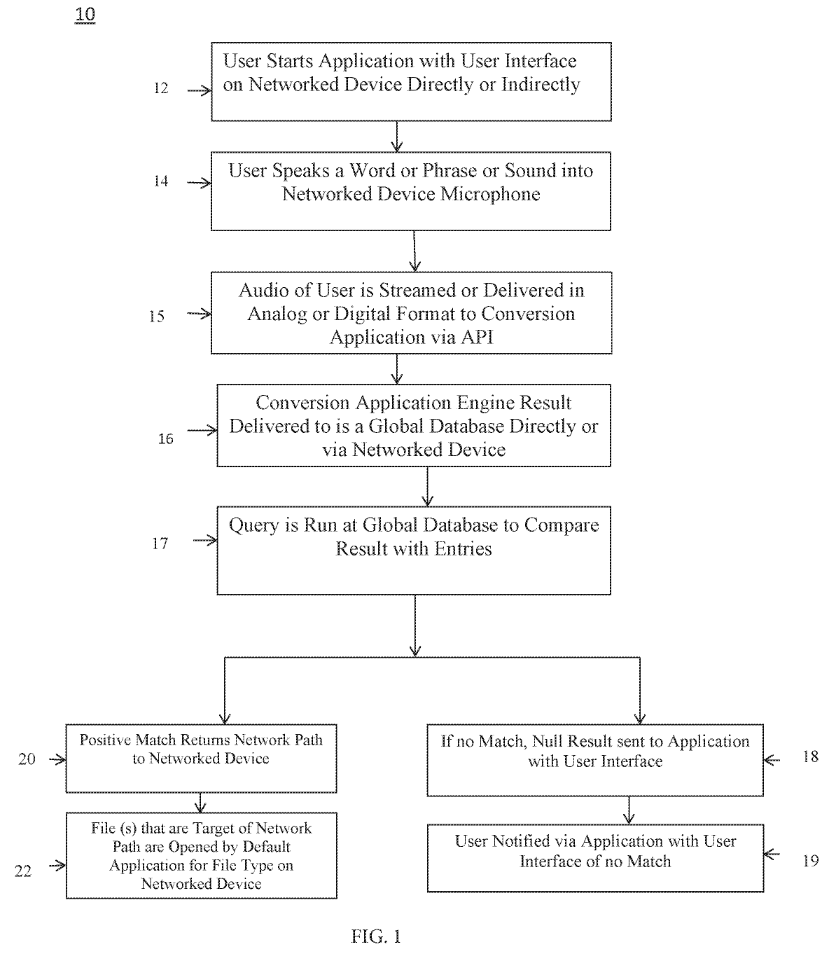

FIG. 1 is a flow chart of a method for global resolution of a network path 10. In block 12, a user starts an application with a user interface on a networked device The application with a user interface can be started by the user manually, or automatically on the networked device. The application with a user interface can be an executable program running on a networked device. The networked device can include components such as a processor, memory, storage, microphone, and operating system. For example, the networked device can be a laptop, smart phone, AI assistant or tablet. The network can be the internet or a local area network. In another embodiment, the application is embedded into networked devices of an Artificial Intelligence (AI) assistant such as Microsoft Cortana, Apple Siri, Amazon Alexa, Google assistant, and the like. The embodiments can have a visual and/or audible user interface to the application.

In block 14, a user provides one or more sounds or speaks one or more words or phrases into a microphone of the networked device. Alternatively, the user can provide a sound into the microphone of the networked device.

In block 15, audio from the application is delivered in real time from the application to a conversion application via the advanced programmer interface (API). For example, the audio can be streamed. Alternatively, the audio from the application is delivered in audio data file format to the conversion application. The conversion application can converts the audio to text. For example, the conversion application can use a speech to text conversion via the advanced programmer interface (API) to transcribe the audio received from the application into text. In one embodiment, the application with a user interface can connect to the remote speech to text server via the advanced programmer interface (API) directly or indirectly. The remote speech to text server running the conversion application. The speech to text server can be a third party speech to text server. Alternatively, the conversion application can utilize phonetic sound maps to transcribe audio of one or more sounds into a searchable format.

In block 16, the result of the conversion application is delivered to a global database. The result can be delivered directly from the conversion application. Alternatively, the result can be forwarded to the global database via the networked device.

In block 17, a query is run at the global database to compare the converted speech and/or one or more sounds with entries of the global database in order to locate a match. In block 18, if no match is found at the global database for the query, a null message is sent from the global database to the application with user interface indicating that there is no match. In block 19, the user is notified via the application with user interface of no match. In block 20, if a match is found at the global database for the query, a network path associated with the result is returned from the global database to the application. For example, the network path delivered to the networked device can be a shared folder on the network, root access to a server or a workstation, or a telephone number. In block 21, one or more files that are a target of the network path are opened. For example, the one or more files that are a target of the network path can be opened by a default application for a file type on the networked device. In one embodiment, the operating system of the networked device can automatically open a Doc file with Microsoft Word on the networked device and present the file to the user within the networked device user interface.

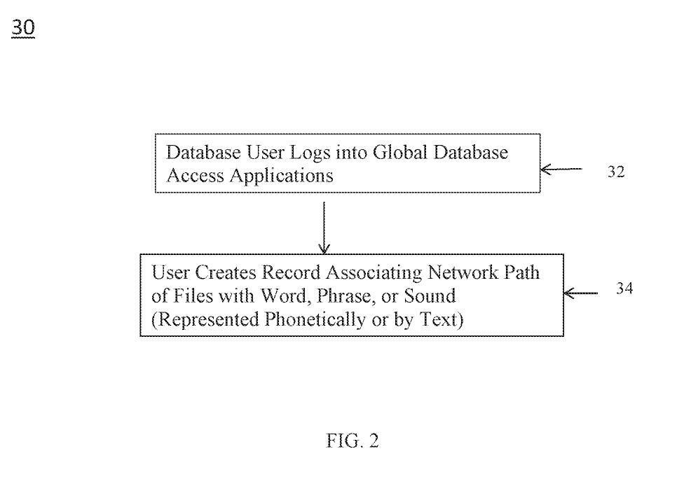

FIG. 2 is a flow chart for a method for establishing a global database of records based on a specific sound or a specific combination of words, phrases and/or sounds 30. In block 32, a user of the global database logs into an access application for the global database. In block 34, the user of the global database creates a record associating a network path of one or more files with a word, phrase or sound or a combination of a word, phrase or sound. The record of the global database can be represented phonetically or by text.

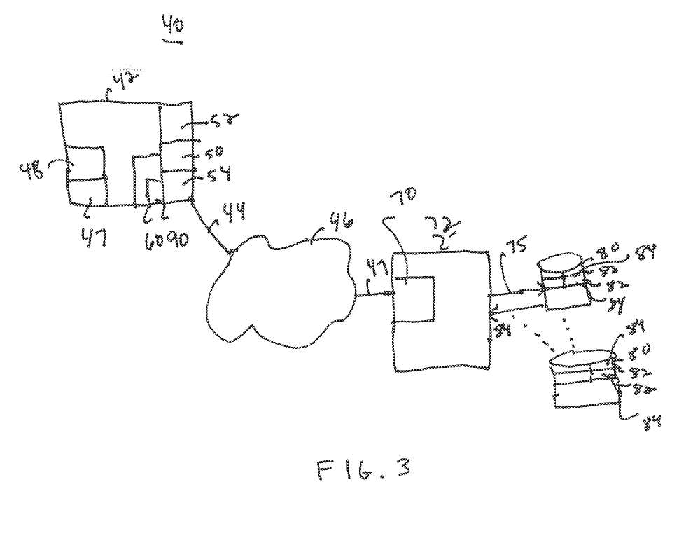

FIG. 3 is a schematic diagram of a system for system for global resolution of a network path to one or more file types based on resolution of a specific sound or a specific combination of words, phrases and/or sounds 40. Networked device 42 connects over connection 44 to network 46. Connection 44 can be a wired or wireless connection. For example, network 46 can the internet or a local area network. Networked device 42 includes microphone 47 and speaker 48. Networked device can include processor 50, memory 52 and operating system 54. For example, networked device 42 can be a laptop, smart phone, AI assistant or tablet.

Application with user interface 60 runs on networked device 42. Application with user interface 60 connects through network 46 over connection 47 to conversion application 70. Conversion application 70 can run on conversion server 72. In one embodiment, application with a user interface 60 can connect to conversion application 70 via an advanced programmer interface (API) of application with user interface 60. Conversion server 72 can be a speech to text server and conversion application 70 can be a speech to text conversion application. Alternatively, conversion server 72 can convert sounds using a conversion application 70 including sound maps to transcribe audio of one or more sounds into a searchable format. A query from output 75 of conversion application 70 can be searched at one or more global databases 80. Global database 80 includes entries 82 of words, phrases, and sounds registered to network path 84. Global database 80 is remote to networked device 42. Network path 84 can be returned to networked device 42. One or more files 90 that are a target of network path 84 can be opened at networked device 42 with application with user interface 60 using a respective file type. In one embodiment, operating system 54 of networked device 42 can automatically open file 90 which is the target of network path 84 on networked device 42 and present file 90 to the user within application with user interface 60.

Embodiments of the present invention can be implemented in connection with a special purpose or general purpose telecommunications device that include both hardware and/or software components, including special purpose or general purpose computers.

Embodiments can also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention.

It is to be understood that the above described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for global resolution of a network path based on a request from a networked device, the method comprising the steps of:
receiving audio of a word, phrase or sound or a combination thereof associated with a network path at a networked device;
converting the audio to a searchable format;
querying the searchable format of the converted audio in a global database for a match, if a match is found at the global database for the query, the network path associated with the match is returned from the global database to the networked device; and
opening one or more files associated with the returned network path at the networked device.

2. The method of claim 1 wherein the audio is received at the networked device at an application with a user interface, the audio from the application is delivered to a conversion application over a network via an advanced programmer interface (API), the conversion application executing the step of converting the audio to a searchable format.

3. The method of claim 2 wherein the application with a user interface is an executable program running on the networked device.

4. The method of claim 2 wherein the audio is delivered in real time from the application with a user interface to the conversion application.

5. The method of claim 2 wherein the audio is streamed from the application with a user interface to the conversion application.

6. The method of claim 1 wherein the one or more files are opened automatically at the networked device upon receiving the returned network path at the networked device.

7. The method of claim 1 wherein the audio is received at a microphone of the networked device.

8. The method of claim 1 wherein the step of converting the audio to a searchable format converts word or phrase to text.

9. The method of claim 1 wherein the step of converting the audio to a searchable format converts a sound to text utilizing a sound map.

10. The method of claim 2 wherein the searchable format of the converted audio is delivered to the global database from the conversion application over a network.

11. The method of claim 2 wherein the searchable format of the converted audio is delivered to the application with a user interface and the application with a user interface delivers the searchable format of the converted audio to the global database over a network.

12. The method of claim 1 wherein the network is the internet.

13. A system for global resolution of a network path based on a request from a networked device , the system comprising:
a global database storing entries of relationships between a searchable format of audio and a network path to target one or more files; and
a conversion server receiving audio from the networked device and converting the audio to a searchable format;
wherein the converted audio in the searchable format is queried in the global database for a match, if a match is found at the global database for the query, the network path associated with the match is returned from the global database to the networked device, and one or more files associated with the returned network path are opened at the networked device.

14. The system of claim 13 wherein the audio is received at the networked device at an application with a user interface executing on the networked device, the audio from the application with a user interface is delivered to the conversion server over a network via an advanced programmer interface (API) to a conversion application executing on the conversion server, the conversion application converting the audio to a searchable format.

15. The system of claim 14 wherein the audio is delivered in real time from the application with a user interface to the conversion application.

16. The system of claim 14 wherein the audio is streamed from the application with a user interface to the conversion application.

17. The system of claim 13 wherein the one or more files are opened automatically at the networked device upon receiving the returned network path at the networked device.

18. The system of claim 13 wherein the audio is received at a microphone of the networked device.

19. The system of claim 13 wherein the audio is a word, phrase or sound or a combination thereof and the searchable format of audio is a conversion of the word or phrase to text and/or a conversion of the sound to text using a sound map.

20. The system of claim 13 wherein the networked device, the global database and the conversion server are connected to one another over one or more networks.

21. The system of claim 20 wherein the network is the internet.

22. A computer-readable medium having stored thereon a plurality of sequences of instructions, said instructions including sequences of instructions which, when executed by at least one processor, cause said processor to: receive audio, forward the audio to a conversion application to convert the audio to a searchable format, query the audio in a searchable format to an entry in a global database of preselected words, phrases or sounds having a relationship to a network path associated with one or more files of interest; determine whether a match exists between the audio is a searchable format and the words, phrases or sounds having a relationship to the network path and when a match exists the network path associated with the match is returned from the global database to the networked device, and the one or more files associated with the returned network path are opened at the networked device.

23. The computer-readable medium of claim 22 the audio is forwarded to the conversion application over a network via an advanced programmer interface (API).
